(19) United States
(12) Patent Application Publication
(10) Pub. No.: US 2012/0305164 A1
(43) Pub. Date: Dec. 6, 2012

(54) METHOD AND DEVICE FOR MELTING A THERMOPLASTIC BY SUPPLYING

(76) Inventors: Ralf Bauer, Schlat (DE); Franz Hepp, Metzingen (DE); Joachim Natrop, Heppenheim (DE)

(21) Appl. No.: 13/515,687

(22) PCT Filed: Jan. 7, 2011
(86) PCT No.: PCT/EP11/00032

§ 371 Date: Aug. 6, 2012

(30) Foreign Application Priority Data
Feb. 8, 2010 (DE) 10 2010 007 317.2

(51) Int. Cl. F17D 3/00; B32B 37/06

(52) U.S. Cl. 156/60; 137/1; 137/602

(57) ABSTRACT

The invention relates to the melting of a thermoplastic, in particular for welding plastic parts (1). The plastic is heated by supplying an exhaust gas. According to the invention, a further gas is mixed with the exhaust gas prior to the supplying process.

The invention relates to a method of melting a thermoplastic, in particular for welding plastic parts, where the plastic is heated with exhaust gas and to an apparatus for melting a thermoplastic, in particular for welding plastic parts, comprising a manifold that has output ports for discharging the hot gas for the purpose of heating the plastic, and a burner to generate exhaust gas in the form of process gas to melt the plastic, and a welding machine to weld the plastic parts.

Convection welding involves directing hot gases precisely onto the surfaces to be joined of parts to be welded together. The parts to be welded, for example, two complementary parts composed of plastic, are oriented, for example opposite one another and a certain distance apart. A tool, for example, can be positioned between the two plastic parts to be welded. Each surface of each part is heated in each case by hot gas from the tool that has two sides for discharging the hot gas. The surfaces to be joined of both plastic parts here are each melted in a contact-free approach by a respective side of the tool. The two surfaces to be joined of the plastic parts are then pressed together, thereby creating a structural component.

DE 10 2007 026 163 [US 2010/0147459] discloses a method and an apparatus for melting a thermoplastic, in particular for welding plastic parts, in which the plastic(s) is/are heated by radiant heat from a radiating body and is/are simultaneously heated by convection by impingement with a hot gas. Heating gas is combusted by a burner in the radiating body. As a result, the radiating body is heated up to a high level and radiates heat from its external surface onto the surfaces to be joined of the plastic parts. The exhaust gas created in the burner accumulates inside the hollow radiating body, exits from output ports in the radiating body, and flows against the surfaces to be joined of the plastic parts.

The disadvantageous aspect here is that the volumetric flow of the exhaust gas can be controlled only by controlling the output of the burner if the volumetric flow of the hot gas for melting and/or welding the plastic is generated only by the burner. A higher volumetric flow here due to the higher required burner output results in a higher temperature for the volumetric flow, while a lower volumetric flow due to the lower required burner output results in a lower temperature for the volumetric flow.

The object of this invention is therefore to provide a method and an apparatus of the type described above that enable the volumetric flow and the temperature of the hot gas to be adjusted independently of each other.

This object is achieved according to the invention by adding a supplementary gas to the exhaust gas before impinging the parts.

An advantageous aspect is that the volumetric flow and the temperature of the outflowing gas mixture can be adjusted in the manifold segment-by-segment by individual distribution chambers. In addition, it is also possible to adjust the volumetric flow and the exit temperature of the gas coming from the individual distribution chambers toward the workpiece to be melted and/or to be welded in a precise fashion within the wide limits necessary so as to compensate for tolerances, welding rib thicknesses, or accumulations of material on the structural component. It is also possible to employ the external burner for various different manifolds that are each connected to the burner by a respective hot-gas conduit. In addition, variation in the temperature of the outflowing gas due to the nonuniform combustion of a gas in a burner can be compensated for by the invention. The adjustability of the volumetric flow and/or of the temperature of the outflowing hot gas from the manifold enables different types of plastic to be welded using the same outflow attachment. The invention also allows the equipment to be quickly adjusted for different types of plastic and/or outflow attachments.

The dependent claims of the invention describe preferred embodiments of the invention:

Mixing the supplementary gas is preferably effected in a manifold having output ports and to which the exhaust gas is added by a burner unit provided in a separate housing.

In order to melt the different plastic parts, the exhaust gas is preferably divided into partial streams to each of which supplementary gas is added.

Mixing the partial streams and the supplementary gas is preferably effected in at least one distribution chamber. The supplementary gas is preferably preheated by the exhaust gas.

For convection welding, the tool has two sides for discharging the hot gas, and the two plastic parts are oriented horizontally with the outflow of the hot gas horizontal relative to their surfaces. The tool and the plastic part here are accordingly oriented horizontally.

Alternatively or in addition, the tool with two sides for discharging the hot gas, and the two plastic parts can be oriented vertically with is, the outflow of the hot gas vertical to the surface. The tool and the plastic part here are oriented vertically.

Control of temperature and volumetric flow are particularly critical with the vertical orientation since the bottom side of the tool is heated more quickly by the accumulation of heat and therefore a lower heat output is required. In addition, the bottom side of the tool can nevertheless require a higher pressure/volumetric flow due to the less favorable outflow downward in order for the hot gas to impact the joining zone of the plastic part with the same velocity.

Preferred embodiments of the invention are described in more detail based on the two figures. Therein:

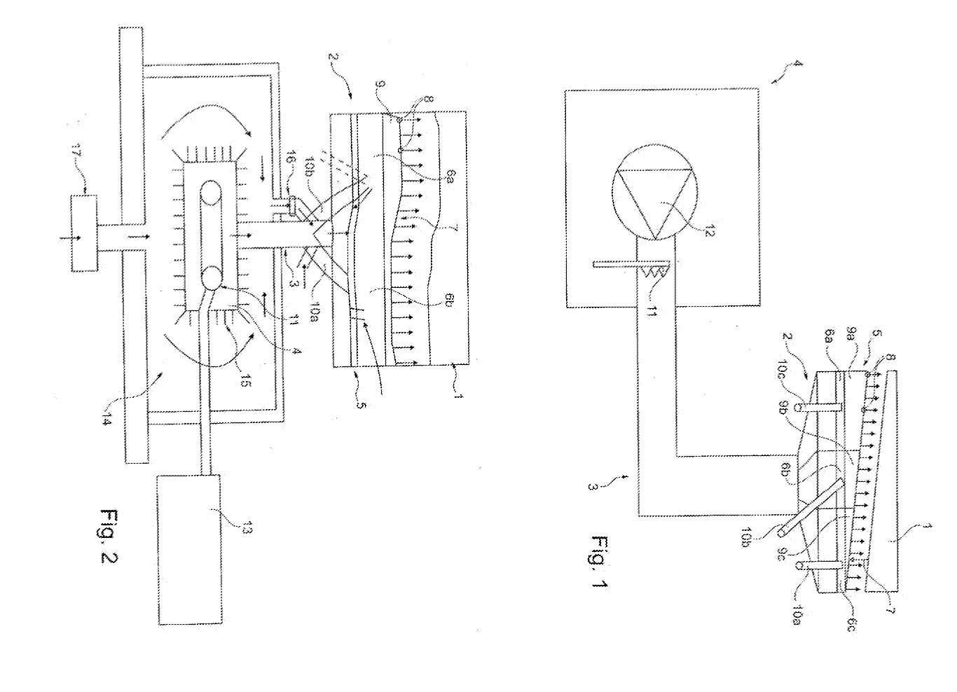

FIG. 1 shows an embodiment of the invention, and

FIG. 2 shows another embodiment of the invention.

A simplified illustration of a welding machine according to the invention is provided in FIG. 1. FIG. 1 illustrates, by way of example, the melting of only one plastic part 1 using the method and apparatus of the invention. The plastic part 1 has a surface to be joined of three-dimensional shape that forms the shape to be welded. After melting, this plastic part 1 is welded (not illustrated) to a second part along the complementary surfaces to be joined of the two parts to form a structural component.

The example shown in FIG. 1 has a tool 2, a hot-gas conduit 3, and a burner unit 4.

The tool 2 has a manifold 5. This manifold 5 has at least one distribution chamber 6a, 6b, 6c for mixing an exhaust gas with a supplementary gas. The manifold 5 in the example of FIG. 1 has three distribution chambers 6a, 6b, 6c that are segmented relative to each other, that is, are separated from each other. This allows the temperature within the three distribution chambers 6a, 6b, 6c to be adjusted zone-by-zone.

FIG. 1 illustrates in simplified form that the tool 2 has only one side for discharging the hot gas.

In addition, the manifold 5 has an outflow attachment 7. The outflow attachment 7 has a two- or three-dimensional shape and can be assembled from at least one attachment plate 9a, 9b, 9c. In the example of FIG. 1, the outflow attachment 7 has a three-dimensional shape and can be assembled from three outflow plates 9a, 9b, 9c. The attachment plates 9a, 9b, 9c serve to distribute the hot, outflowing gas uniformly along the surface to be joined of the part 1. The outer shape of the manifold 5 is at least partially matched in shape to the shape of the part 1 to be heated by the outflow attachment 7, thereby providing the most consistent possible spacing between the outflow attachment 7 and the surface to be joined of the part 1. The surface of the manifold 5 is also shaped to match the surface to be joined of the part 1 by the outflow attachment 7. The outflow attachment 7 has at least one output port 8 and/or at least one inserted tube for discharging the hot gas. The outflow attachment 7 in the example of FIG. 1 has multiple output ports 8 that follow the shape of the surface to be joined of the part 1. The distance between the outflow attachment 7 and the surface to be welded of the part 1 must be set at 2 mm to 5 mm.

The manifold 5 has at least one additional supply line 10a, 10b, 10c. In the example of FIG. 1, the manifold 5 has three supply lines 10a, 10b, 10c to supply the supplementary gas.

The hot-gas conduit 3 in FIG. 1 is also connected to the manifold 5.

The burner unit 4 with its separate housing is connected at the back side of the tool 2 to the hot-gas conduit 3. A burner 11 is provided in the burner unit 4. The burner 11 can be positioned on the sliding frame for the tool 2 or in the machine frame. A blower 12 can be provided upstream or downstream of the burner 11 in the burner unit 4. In the example of FIG. 1, the blower 12 is provided upstream of the burner 11 relative to the direction of flow for the blower 12.

At least one temperature sensor is positioned in the tool 2 to measure the temperature of the hot outflowing gas. In the example of FIG. 1, one temperature sensor each is positioned in respective distribution chambers 6a, 6b, 6c to measure the temperatures of the hot outflowing gas.

The separate burner 11 associated with the tool 2 that has the manifold 5 allows for a separate temperature/output control. Alternatively or in addition, a separate burner 11 can be associated with each distribution chamber 6a, 6b, 6c of the tool 2, in particular whenever melting very large and/or complex plastic parts 1 is required.

A gas, preferably a mixture of methane and air, is combusted to generate the exhaust gas. Burning methane creates water vapor that has an advantageous effect on the welding process. The blower 12 enables the exhaust gas to flow as process gas from the burner unit 4 into the hot-gas conduit 3. The exhaust gas is divided up into respective partial flows, each of which is introduced into respective distribution chambers 6a, 6b, 6c of the manifold 5. Depending on the part 1 to be welded, the respective flows of exhaust gas are divided up in appropriate fractional amounts to create a partial flow in order, for example, to compensate for differences in thickness in the various surfaces to be joined of the part 1.

When the burner unit 4 is at an optimal setting, the exhaust gas flows without the admixture of a supplementary gas via output ports 8 through the outflow attachment 7 onto the surface to be joined of the part 1, thereby melting this surface. The temperature in distribution chambers 6a, 6b, 6c is measured here by the respective temperature sensors.

Alternatively or in addition, a supplementary gas in the form of added air (bypass) can be added to the individual partial flows of exhaust gas through the respective supply lines 10a, 10b, 10c to compensate for deviations in temperature and/or volumetric flow when melting the surface to be joined of the part 1. The gas added through supply lines 10a, 10b, 10c is mixed with the partial flows of the exhaust gas in the respective distribution chambers 6a, 6b, 6c to produce a hot gas. The gas added through the supply lines 10a, 10b, 10c is also homogenized here with the partial flows of exhaust gas in the respective distribution chambers 6a, 6b, 6c. The hot gas then exits from the output ports 8 of the outflow attachment 7 onto the surface to be joined of the part 1 and the surface to be joined of the part 1 is melted.

The part 1 is then joined to a second part, thereby producing, for example, a container.

A second embodiment of the invention is shown in FIG. 2. Identical components are designated with identical reference numerals, while new components are designated by new reference numerals.

A surface to be joined of the part 1 that has a three-dimensional shape is melted using the tool 2 in a welding unit to weld plastic parts 1. FIG. 2 shows the apparatus in simplified form. The tool 2 is shown in FIG. 2 in simplified form with only one side discharging the hot gas.

The tool 2 is composed of the manifold 5 that has two distribution chambers 6a and 6b. The manifold 5 furthermore has the outflow attachment 7 that is composed of a single attachment plate 9 in the example and has a three-dimensional shape that is complementary to the surface to be joined of the part 1. The outflow attachment 7 has multiple output ports 8 each of which is matched in shape to the shape of the surface to be joined of the part 1.

Each of the two distribution chambers 6a and 6b of the manifold 5 has a respective supply line 10a and 10b. A valve 16 is provided in one of supply lines 10b. The volume of the inflowing supplementary gas can be adjusted by the valve 16.

At least one temperature sensor is positioned in the tool 2 to measure the temperature of the hot outflowing gas. In the example of FIG. 1, a respective temperature sensor is provided in each of the distribution chambers 6a and 6b to measure the temperature of the respective hot outflowing gas.

The apparatus of FIG. 2 furthermore has the burner unit 4 that has the burner 11, the hot-gas conduit 3, and a gas-air mixer 13 in which the gas to be combusted is premixed.

Alternatively, the apparatus can also include more than one gas-air mixer 13.

In addition, the apparatus has a chamber 14 and multiple cooling ribs 15. The chamber 14 encloses the burner unit 4 that is surrounded by a housing made up of the cooling ribs 15. In addition, the apparatus has another incoming supply blower 17. The gas-air mixer 13 is connected to the burner 11 by a conduit. The burner unit 4 in a separate housing is connected by the hot-gas conduit 3 to the manifold 5. The incoming supply blower 17 is connected to the chamber 14 by a conduit. Coming from the chamber 14, one supply line 10b leads to the manifold 5.

The heating gas, preferably methane and air, is mixed in the gas-air mixer 13 to melt the surface to be joined of the part 1. The heating gas flows through the hot-gas conduit 3 and burns in this burner to produce an exhaust gas. The exhaust gas flows through the hot-gas conduit 3 into the manifold 5. To this end, the exhaust gas is divided into two partial flows, one partial flow being introduced into the first distribution chamber 6a and the second partial flow being introduced into the second distribution chamber 6b. Coming from the two distribution chambers 6a and 6b, the exhaust gas flows via the outflow attachment 7 through the output ports 8 onto the surface to be joined of the part 1. Depending on the shape and type of surface to be joined for the part 1, respectively appropriate amounts of the partial flows are passed into the two distribution chambers 6a and 6b. The temperature in distribution chambers 6a and 6b is measured here by the respective temperature sensors.

Alternatively and in addition, a supplementary gas can be added to the partial flows of the exhaust gas in order to adjust the volumetric flow and temperature of the outflowing hot gas from output ports 8. To this end, an unheated supplementary gas that is at a lower temperature than the exhaust gas is conveyed by the incoming supply blower 17 through the conduit into the chamber 14. Combusting the mixture of methane and air to produce the exhaust gas enables the cooling ribs 15 to transfer heat from the exhaust gas to the supplementary gas by thermal transfer.

The supplementary gas that has been preheated by the exhaust gas in the chamber 14 flows from the chamber 14 via the supply line 10b, from this line into each of distribution chambers 6a and 6b, and mixes there with the exhaust gas. In the process, the supplementary gas also blends with the exhaust gas in the distribution chambers 6a and 6b. The volume of supplied supplementary gas can be adjusted through supply line 10b by the valve 16.

Alternatively or in addition, a further supplementary gas can flow into respective distribution chambers 6a, 6b through the supply line 10a and mix with the gases in these chambers. In the process, the supplementary gas also blends with the hot gases in the distribution chambers 6a and 6b.

After the surface to be joined is melted, the part 1 is joined to another part, thereby producing a container, for example.

1. In a method of melting a thermoplastic for welding plastic parts where the plastic is heated with exhaust gas, the improvement comprising the step of:
adding a supplementary gas to the exhaust gas before impinging the parts with the heated exhaust gas.

2. The method according to claim 1, further comprising the steps of:
mixing the supplementary gas in a manifold that has output ports, and
supplying the exhaust gas to the manifold by a burner unit provided in a separate housing.

3. The method according to claim 1, further comprising the steps of:
dividing the exhaust gas into partial flows, and
adding to each of the partial flows a supplementary gas in order to melt different plastic parts.

4. The method according to claim 1, further comprising the step of:
mixing the partial flows of exhaust gas with the supplementary gas in the manifold in at least one distribution chamber.

5. The method according to claim 1, further comprising the step of:
preheating the supplementary gas with the exhaust gas.

6. An apparatus for melting a thermoplastic for welding plastic parts, the apparatus comprising:
a manifold that has output ports for discharging a hot gas for the purpose of heating the plastic of the parts, and
a burner for generating exhaust gas in the form of process gas to melt the plastic of the parts and provided in a burner unit that has a separate housing and that is connected to the manifold by a hot-gas conduit,
at least one additional supply line connected to the manifold for supplying thereto a supplementary gas that is added to the exhaust gas.

7. The apparatus according to claim 6, wherein the manifold has at least one distribution chamber for mixing the exhaust gas and the supplementary gas.

8. The apparatus according to claim 6, further comprising:
a blower upstream or downstream of the burner in the burner unit.

9. The apparatus according to claim 6, wherein a separate burner is associated with each tool that has the manifold.

10. The apparatus according to claim 6, wherein the burner unit is surrounded by a chamber for preheating the supplementary gas.

11. The apparatus according to 6, wherein the outer shape of the manifold is at least partially matched in shape by an outflow attachment to the shape of the plastic parts to be heated.

12. The apparatus according to claim 11, wherein the surface of the manifold is matched in shape by the outflow attachment to the surface to be joined of the plastic parts.

13. The apparatus according to claim 11, wherein the outflow attachment has a two- or three-dimensional shape.

14. The apparatus according to claim 11, wherein the outflow attachment has at least one output port or at least one inserted tube for discharging the hot gas.

15. The apparatus according to claim 11, wherein the outflow attachment can be assembled from at least one attachment plate.

16. The method according to claim 11, wherein a spacing between the outflow attachment and the plastic to be welded is 2 mm to 5 mm.

17. (canceled)
